(19) United States
(12) Patent Application Publication
(10) Pub. No.: US 2010/0087235 A1
(43) Pub. Date: Apr. 8, 2010

(54) Loop antenna for cell phone having a metallic or non-metallic casing

(76) Inventor: Chi-Ming Chiang, Pa-Te City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/285,539

(22) Filed: Oct. 8, 2008

(51) Int. Cl. H04M 1/00

(52) U.S. Cl. 455/575.7

(57) ABSTRACT

A loop antenna used in a cell phone having a circuit board and a casing housing the circuit board is disclosed to include a loop extending around the border of the circuit board, a ground end extending from one end of the loop and electrically connected to a ground plane of the circuit board, a feed end extending from the opposite end of the loop and electrically connected to the circuit board for signal input, and two cut-off ends formed in a middle part of the loop to cut off the loop. The two cut-off ends are electrically connected to the casing of the cell phone if the casing is a metallic casing, or short-circuited if the casing of the cell phone is a non-metallic casing.

### BACKGROUND OF THE INVENTION

1. Field of the Invention

The present invention relates to a cell phone antenna and more particularly, to a high-performance loop antenna practical for use in a cell phone having a metallic or non-metallic casing.

2. Description of the Related Art

A cell phone generally comprises an antenna electrically connected to the circuit board thereof for signal input/output. Following the market tendency toward the design having a compact characteristic, the space in a cell phone for antenna is limited. To save space occupation, loop antenna is the best choice for cell phone.

Conventionally, a loop antenna for cell phone is formed of a strip-like metal conductor arranged inside the casing of the cell phone in the form of a loop and electrically connected to the circuit board of the cell phone for multi-band operation.

The casing of a cell phone may be prepared from a metallic material. Surrounding the loop antenna of a cell phone with a metallic casing may cause a shielding effect, weakening the signal.

Therefore, it is desirable to provide a loop antenna for cell phone that eliminates the aforesaid problem.

### SUMMARY OF THE INVENTION

The present invention has been accomplished under the circumstances in view. It is therefore the main object of the present invention to provide a loop antenna, which is practical for use in a cell phone having a metallic casing as well as a cell phone having a non-metallic casing without encountering any shielding effect.

To achieve this and other objects of the present invention, the loop antenna is used in a cell phone having a circuit board and a casing that houses the circuit board, comprising a loop extending around the border-of the circuit board, a ground end extending from one end of the loop and electrically connected to a ground plane of the circuit board, a feed end extending from the other end of the loop and electrically connected to the circuit board for signal input, and two cut-off ends formed in a middle part of the loop to cut off the loop. If the casing of the cell phone is a metallic casing, the two cut-off ends are electrically connected to the metallic casing of the cell phone. If the casing of the cell phone is a non-metallic casing, the two cut-off ends are short-circuited.

Therefore, when the loop antenna is used in a cell phone having a metallic casing, the metallic casing of the cell phone works as a part of the loop antenna, avoiding a shielding effect. When the loop antenna is used in a cell phone having a non-metallic casing, the two cut-off ends of the loop antenna are short-circuited. Therefore, the design of the loop antenna in accordance with the present invention is suitable for use in any of a variety of cell phones.

Further, the loop antenna can be integrally formed in the circuit board of a cell phone. Alternatively, the loop antenna can be separately made and then installed in the circuit board of a circuit board.

### BRIEF DESCRIPTION OF THE DRAWINGS

FIG. 1 is a perspective view of a loop antenna installed in a circuit board according to the present invention (the imaginary line indicates the circuit board).

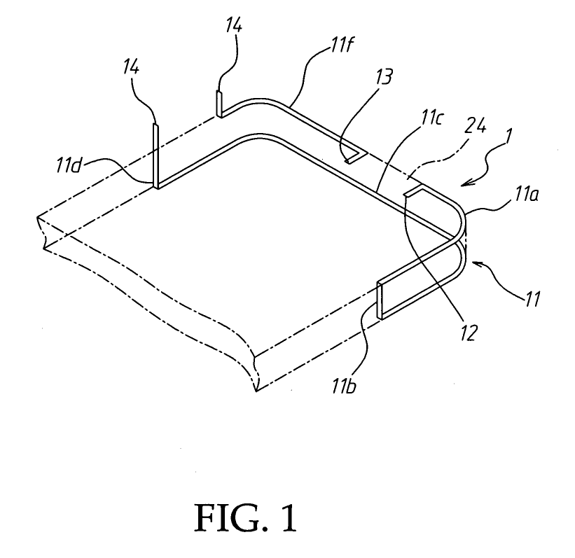

FIG. 2 is an oblique top elevation of the circuit board with the loop antenna according to the present invention.

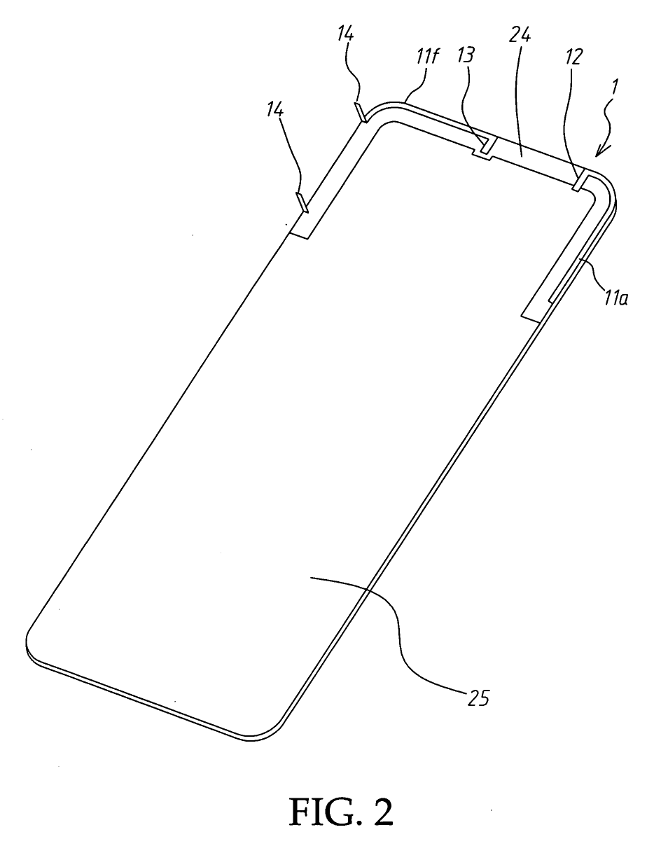

FIG. 3 is an oblique bottom elevation of the circuit board with the loop antenna according to the present invention.

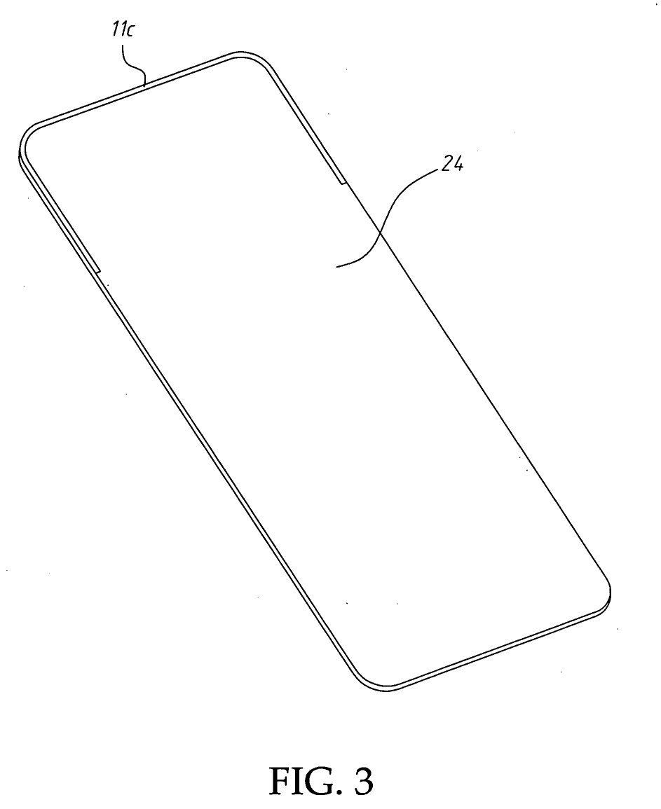

FIG. 4 is an exploded view of a cell phone constructed according to the present invention.

FIG. 5 is a VSWR diagram obtained from a loop antenna with a metallic casing according to the present invention.

FIG. 6 is a VSWR diagram obtained from a loop antenna without a metallic casing according to the present invention.

### DETAILED DESCRIPTION OF THE PREFERRED EMBODIMENT

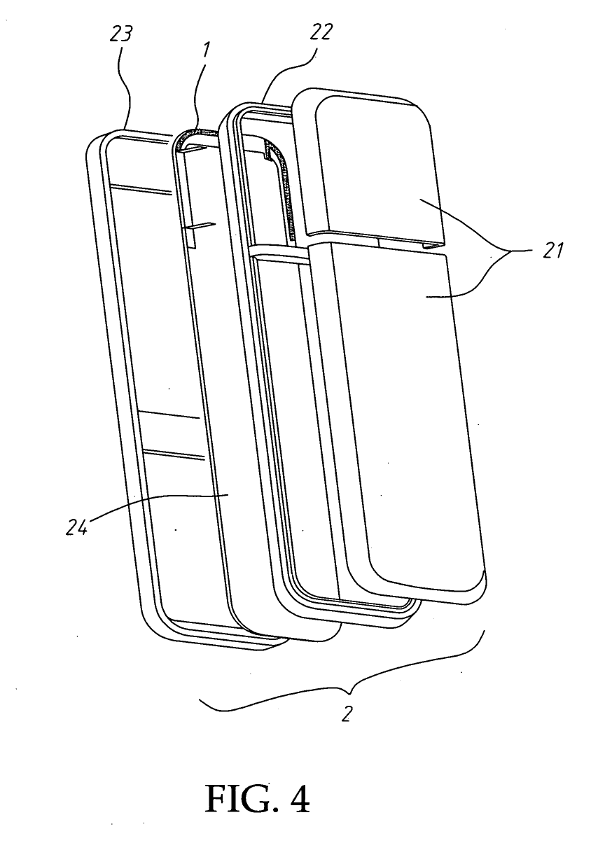

Referring to FIGS. 13, a loop antenna 1 is shown used in a cell phone 2 that (see FIG. 4) comprises an upper cover shell 21, a bottom cover shell 23, a packing frame 22 and a circuit board 24. The loop antenna 1 comprises a loop 11, a ground end 12, a feed end 13, and two cut-off ends 14.

The loop 11 extends along the border of the circuit board 24 of the cell phone 2. The ground end 12 extends from one end of the loop 11, and is electrically connected to the ground plane 25 of the circuit board 24. The feed end 13 extends from the other end of the loop 11, and is electrically connected to the circuit board 24 for signal input. The middle part of the loop 11 is cut off, forming two cut-off ends 14.

If the upper cover shell 21 and bottom cover shell 23 of the cell phone 2 are metallic shells and the packing frame 22 is a plastic packing member, the two cut-off ends 14 are electrically connected to the metallic upper cover shell 21 to have the metallic upper cover shell 21 be a part of the loop antenna, preventing the metallic casing of the cell phone from shielding the loop antenna. If the upper cover shell 21 and bottom cover shell 23 of the cell phone 2 are plastic shells, as shown in FIG. 4, the two cut-off ends 14 are short-circuited.

Referring to FIGS. 13 again, the loop antenna 1 is divided into multiple segments, i.e., the first segment 11a started from the ground end 12 and extending along the border of the top wall of the circuit board 24 to one lateral side of the circuit board 24, the second segment 11b vertically downwardly extending from one end of the first segment 11a remote from the ground end 12 across the wall thickness of the circuit board 24 to the bottom side of the circuit board 24, the substantially π-shaped third segment 11c extending along the border of the bottom wall of the circuit board 24 to the other lateral side of the circuit board 24, a fourth segment 11d vertically upwardly extending from one end of the third segment 11c opposite to the second segment 11b across the wall thickness of the circuit board 24 to the top side of the circuit board 24 and then terminating in one cut-off end 14, and the fifth segment 11f extending from the other cut-off end 14 along the border of the top wall of the circuit board 24 to the feed end 13 that is electrically connected to the circuit board 24 for signal input.

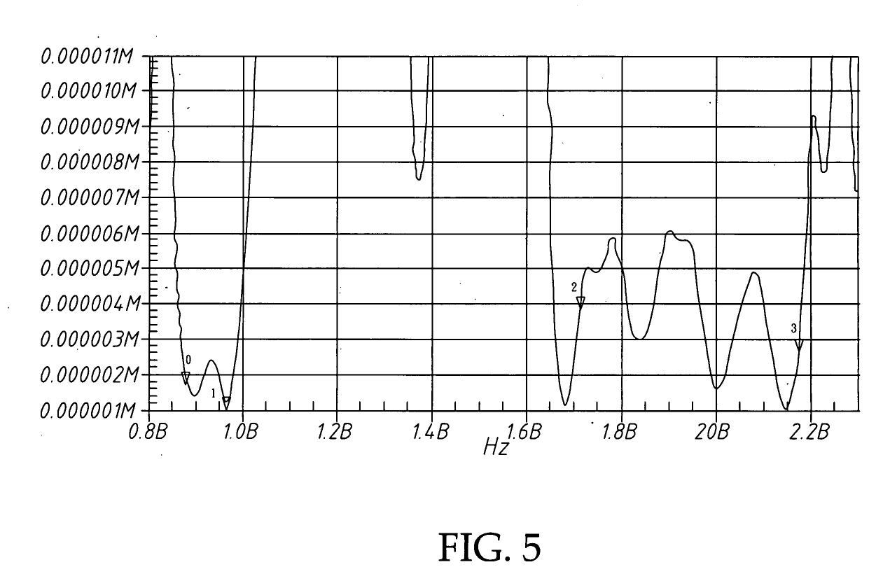

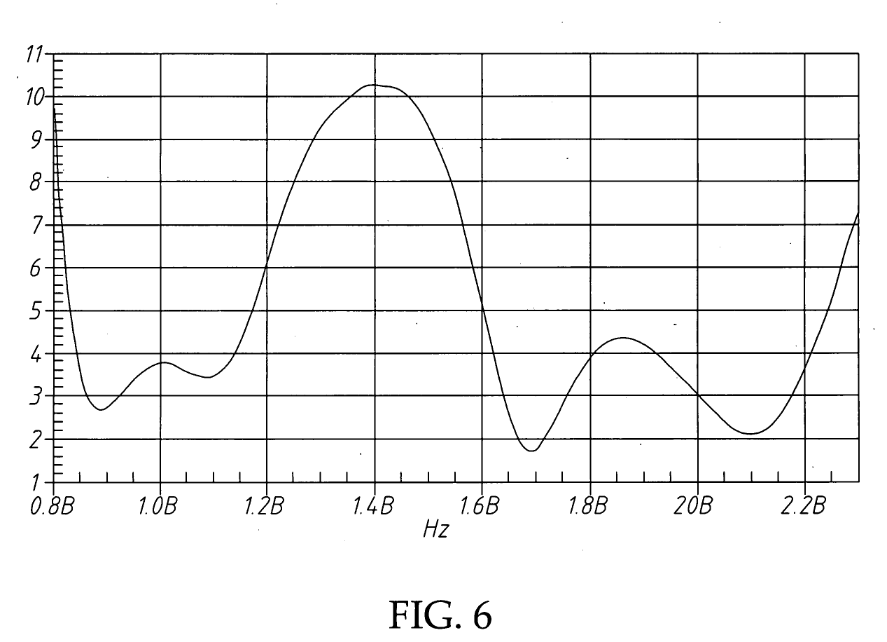

FIG. 5 and FIG. 6 are VSWR diagrams obtained from two loop antenna samples (one installed in a cell phone having a metallic casing and the other installed in a cell phone having a plastic casing) according to the present invention.

The following table is a 3D Gain Table obtained from a loop antenna with a metallic casing according to the present invention:

| | Frequency | | Directivity | | Radiation | Mismatch | Total |
|---|---|---|---|---|---|---|---|
| System | (MHz) | VSWR | (dBi) | Gain (dBi) | Eff (%) | Eff | Eff (%) |
| | 800 | 1.8 | 4.16 | 0.84 | 46.51 | 90.85 | 42.25 |
| | 920 | 2.1 | 3.26 | 2.29 | 79.85 | 86.95 | 69.44 |
| | 960 | 1.2 | 4.48 | 2.73 | 66.83 | 97.85 | 65.4 |
| | 1710 | 3.9 | 5.47 | 2.84 | 54.6 | 66.88 | 36.52 |
| | 1800 | 4.4 | 5.96 | 4.12 | 65.49 | 56.44 | 36.96 |
| | 1800 | 5 | 5.49 | 3.53 | 63.66 | 55.75 | 35.49 |
| | 1990 | 1.8 | 4.29 | 1.98 | 58.68 | 90.21 | 52.94 |
| | 2179 | 2.8 | 5.77 | 3.99 | 66.43 | 80.71 | 53.62 |

The following table is a 3D Gain Table obtained from a loop antenna without a metallic casing (with a non-metallic casing) according to the present invention:

| | Frequency | | Directivity | | Radiation | Mismatch | Total |
|---|---|---|---|---|---|---|---|
| System | (MHz) | VSWR | (dBi) | Gain (dBi) | Eff (%) | Eff | Eff (%) |
| | 800 | 2.7 | 1.99 | −2.02 | 39.61 | 78.57 | 31.12 |
| | 920 | 2.9 | 2.08 | −1.39 | 44.92 | 75.26 | 33.8 |
| | 960 | 3.4 | 2.12 | −1.08 | 47.77 | 69.38 | 33.14 |
| | 1710 | 1.8 | 3.01 | −0.42 | 45.35 | 91.22 | 41.37 |
| | 1800 | 3.8 | 3.85 | 1.1 | 53.14 | 65.76 | 34.94 |
| | 1880 | 4.3 | 4.09 | 1.85 | 59.72 | 60.87 | 36.36 |
| | 1990 | 3.2 | 4.42 | 2.31 | 61.57 | 71.71 | 44.15 |
| | 2179 | 2.7 | 4.47 | 0.1 | 36.57 | 77.94 | 28.5 |

From the above two tables, it is fully understood that the loop antenna constructed in accordance with the present invention is practical for application to a cell phone with a metallic casing as well as a cell phone with a non-metallic casing, providing multiple excellent operation bands.

Further, during fabrication of the loop antenna 1, it can be directly formed in the circuit board 24 by means of an etching technique, or separately made and then installed in the circuit board 24.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A loop antenna installed in a cell phone comprising a casing and a circuit board mounted in said casing, the loop antenna comprising:
a loop extending around the border of said circuit board;
a ground end extending from one end of said loop and electrically connected to a ground plane of said circuit board;
a feed end extending from an opposite end of said loop and electrically connected to said circuit board for signal input; and
two cut-off ends formed in a middle part of said loop to cut off said loop;
wherein said two cut-off ends are electrically connected to the casing of said cell phone when the casing of said cell phone is a metallic casing; said two cut-off ends are short-circuited when the casing of said cell phone is a non-metallic casing.

2. The loop antenna as claimed in claim 1, wherein said loop, said ground end and said feed end are formed integrally in said circuit board by an etching technique.

3. The loop antenna as claimed in claim 1, wherein said loop, said ground end and said feed end are formed in integrity beyond said circuit board and then installed in said circuit board.
